(19) United States
(12) Patent Application Publication
(10) Pub. No.: US 2023/0050426 A1
(43) Pub. Date: Feb. 16, 2023

(54) CONSUMABLE FOR USE WITH A NONCOMBUSTIBLE AEROSOL PROVISION DEVICE

(71) Applicant: Nicoventures Trading Limited, London (GB)

(72) Inventors: Patrick MOLONEY, London (GB); Anton KORUS, London (GB)

(21) Appl. No.: 17/792,729

(22) PCT Filed: Jan. 18, 2021
(86) PCT No.: PCT/GB2021/050107

§ 371 Date: Jul. 14, 2022

(30) Foreign Application Priority Data
Jan. 16, 2020 (GB) 2000687.0
Jan. 16, 2020 (GB) PCT/GB2020/052757

(51) Int. Cl. A24F 40/465; A24C 5/01; A24F 40/20; A24D 1/20; H05B 6/10; H05B 6/44

(52) U.S. Cl. CPC A24F 40/465; A24C 5/01; A24F 40/20; A24D 1/20; H05B 6/105; H05B 6/44

(57) ABSTRACT

A method of manufacturing a consumable for use in a non-combustible aerosol provision device which comprises providing a susceptor arrangement (1) comprising first and second susceptor portions (2) and a connector (3) joining the first and second susceptor portions to each other, wherein the first and second susceptor portions are spaced apart from each other by the connector. The method further comprises forming an assembly comprising the susceptor arrangement and aerosol-generating material and dividing the assembly, wherein the dividing comprises dividing the connector and the aerosol-generating material. According to the present disclosure, there is also provided a susceptor arrangement for use in a method of manufacturing a consumable for use with a non-combustible aerosol provision device, an assembly for use in a method of manufacturing a consumable, a consumable for use with a non-combustible aerosol provision device, and non-combustible aerosol provision system.

### TECHNICAL FIELD

The present disclosure relates to a method of manufacturing a consumable for use in a non-combustible aerosol provision device, a susceptor arrangement for use in a method of manufacturing a consumable for use with a non-combustible aerosol provision device, an assembly for use in a method of manufacturing a consumable for use with a non-combustible aerosol provision device, consumable for use with a non-combustible aerosol provision device, and a non-combustible aerosol provision system.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

### SUMMARY

According to a first aspect of the present disclosure, there is provided a method of manufacturing a consumable for use in a non-combustible aerosol provision device, the method comprising: providing a susceptor arrangement comprising first and second susceptor portions and a connector joining the first and second susceptor portions to each other, wherein the first and second susceptor portions are spaced apart from each other by the connector; forming an assembly comprising the susceptor arrangement and aerosol-generating material; and dividing the assembly, wherein the dividing comprises dividing the connector and the aerosol-generating material.

Optionally, the dividing comprises using a cutter to cut the connector.

Optionally, the forming comprises at least partially embedding the susceptor arrangement in the aerosol-generating material.

Optionally, the forming comprises: combining the susceptor arrangement with the aerosol-generating material on a wrapper; and wrapping the wrapper around the susceptor arrangement and the aerosol-generating material.

Optionally, the susceptor arrangement is placed on the wrapper before the aerosol-generating material.

Optionally, the aerosol-generating material is placed on the wrapper before the susceptor arrangement.

Optionally, the connector comprises a weakened region of the susceptor arrangement.

Optionally, the susceptors are integrally formed with the weakened region.

Optionally, the connector comprises a carrier to which the susceptors are affixed.

Optionally, the carrier comprises heating material that is heatable by penetration with a varying magnetic field.

Optionally, the carrier is free from heating material that is heatable by penetration with a varying magnetic field.

Optionally, the carrier comprises one or more of: paper, metal foil, metal alloy foil, and aerosol-generating material.

According to a second aspect of the present disclosure, there is provided a susceptor arrangement for use in a method of manufacturing a consumable for use with a non-combustible aerosol provision device, the susceptor arrangement comprising first and second susceptor portions and a connector joining the first and second susceptor portions to each other, wherein the first and second susceptor portions are spaced apart from each other by the connector.

Optionally, the connector comprises a weakened region of the susceptor arrangement.

Optionally, the susceptor portions are integrally formed with the weakened region.

Optionally, the susceptor arrangement comprises at least one further susceptor portion and at least one further connector, wherein the susceptor arrangement is arranged such that a repeating sequence of susceptor portion followed by connector followed by susceptor portion is present.

Optionally, the connector comprises a carrier to which the susceptor portions are affixed.

Optionally, the susceptor arrangement comprises at least one further susceptor portion and wherein the first susceptor portion, the second susceptor portion and at least one further susceptor portion are affixed to the carrier.

Optionally, the susceptor portions are spaced apart from one another on the carrier, and wherein the carrier comprises a weakened region between the susceptor portions.

Optionally, the carrier comprises heating material that is heatable by penetration with a varying magnetic field.

Optionally, the carrier is free from heating material that is heatable by penetration with a varying magnetic field.

Optionally, the carrier comprises one or more of: paper, metal foil, metal alloy foil, and aerosol-generating material.

In some embodiments, the susceptor arrangement comprises a plurality of first susceptor portions and a plurality of second susceptor portions.

In some embodiments, the first susceptor portions overlap in an axial direction of the susceptor arrangement and/or the second susceptor portions overlap in an axial direction of the susceptor arrangement.

In some embodiments, the first susceptor portions are parallel to each other. For example, the longitudinal axis of the first susceptor portions may be in parallel.

In some embodiments, the second susceptor portions are parallel to each other. For example, the longitudinal axis of the second susceptor portions may be in parallel.

In some embodiments, the first susceptor portions co-extend and/or the second susceptor portions co-extend.

In some embodiments, each first susceptor portion is aligned with a corresponding second susceptor portion.

In some embodiments, the longitudinal axis of each first susceptor portion is aligned with the longitudinal axis of a corresponding second susceptor portion in a direction perpendicular to the longitudinal axes.

In some embodiments, the susceptor arrangement comprises at least two, three, four, five, six, seven, eight, nine or ten first susceptor portions. In some embodiments, the susceptor arrangement comprises two, three, four, five, six, seven, eight, nine or ten first susceptor portions.

In some embodiments, the susceptor arrangement comprises at least two, three, four, five, six, seven, eight, nine or ten second susceptor portions. In some embodiments, the susceptor arrangement comprises two, three, four, five, six, seven, eight, nine or ten second susceptor portions.

In some embodiments, the connector joins each first susceptor portion to a respective second susceptor portion such that each first susceptor portion is spaced from the respective second susceptor portion by the connector. The connector may comprise a carrier, wherein the carrier joins each first susceptor portion to a respective second susceptor portion. In some embodiments, the carrier comprises a sheet material.

In some embodiments, the susceptor arrangement comprises a plurality of connectors, each connector joining a first susceptor portion to a respective second susceptor portion such that each first susceptor portion is spaced from the respective second susceptor portion by the respective connector. In some embodiments, each connector comprises a weakened region.

In some embodiments, dividing the assembly comprises dividing each connector and the aerosol-generating material.

In some embodiments, connectors of the susceptor arrangement are spaced apart from each other.

In some embodiments, the first susceptor portions of the assembly are substantially equally spaced and/or the second susceptor portions of the assembly are substantially equally spaced.

According to a third aspect of the present disclosure, there is provided an assembly for use in a method of manufacturing a consumable for use with a non-combustible aerosol provision device, the assembly comprising: the susceptor arrangement according to the second aspect of the present disclosure; and aerosol-generating material in thermal contact with the susceptor arrangement; wherein the assembly is dividable by a process comprising dividing the connector and the aerosol-generating material.

Optionally, the assembly comprises a wrapper that is wrapped around the susceptor arrangement and the aerosol-generating material.

According to a fourth embodiment of the present disclosure, there is provided a consumable for use with a non-combustible aerosol provision device, the consumable being manufactured according to a method comprising the method according to the first aspect of the present disclosure.

According to a fifth aspect of the present disclosure, there is provided a consumable for use with a non-combustible aerosol provision device, the consumable comprising: at least one susceptor portion and a connector portion affixed to or integrally formed with the or each susceptor portion, and aerosol-generating material in thermal contact with the or each susceptor portion; wherein the connector portion extends to at least one end of the aerosol-generating material.

Optionally, the consumable comprises a susceptor arrangement that comprises the at least one susceptor portion, wherein the connector portion comprises a weakened region of the susceptor arrangement.

Optionally, the weakened region is integrally formed with the at least one susceptor portion.

Optionally, the connector portion comprises a carrier to which the at least one susceptor portion is affixed.

Optionally, the or each susceptor portion is at least partially embedded in the aerosol-generating material.

Optionally, the or each susceptor portion is substantially coaxial with a central axis of the consumable.

Optionally, the carrier comprises heating material that is heatable by penetration with a varying magnetic field.

Optionally, the carrier is free from heating material that is heatable by penetration with a varying magnetic field.

Optionally, the carrier comprises one or more of: paper, metal foil, metal alloy foil, and aerosol-generating material.

Optionally, the or each susceptor portion comprises one or more materials selected from the group consisting of: aluminium, gold, iron, nickel, cobalt, conductive carbon, graphite, steel, plain-carbon steel, mild steel, stainless steel, ferritic stainless steel, molybdenum, silicon carbide, copper, and bronze.

Optionally, the or each susceptor portion comprises nickel.

Optionally, the or each susceptor portion comprises steel with a nickel coating.

Optionally, the susceptor arrangement comprises perforations.

Optionally, the susceptor arrangement comprises a weakened region.

Optionally, the susceptor arrangement comprises first and second materials that are different.

Optionally, the or each susceptor portion comprises a first region comprising the first material and a second region comprising the second material.

Optionally, the first and second materials have a different electrical conductivity and/or magnetic electrical conductivity.

Optionally, the first material comprises a material that is heatable by penetration with a varying magnetic field and the second material comprises a material that is not, or substantially is not, heatable by penetration with a varying magnetic field.

Optionally, one of first and second materials is coated with the other one of the first and second materials.

Optionally, the first material is coated with the second material.

Optionally, the first and second materials are configured such that, in use, when the first and second materials are penetrated by a varying magnetic field, the penetration of the first and second materials by the varying magnetic field causes a temperature difference between the first and second materials.

Optionally, the first and second materials have different thermal masses.

Optionally, the or each susceptor portion comprises a base portion and an embeddable portion for at least partially embedding in aerosol-generating material.

Optionally, the base portion is generally flat.

Optionally, the base portion is generally circular.

Optionally, the base portion is comprises a material that is heatable by penetration with a varying magnetic field.

Optionally, the embeddable portion comprises a thermally conductive material.

Optionally, the embeddable portion comprises a material that is heatable by penetration with a varying magnetic field.

Optionally, the embeddable portion comprises a material that is not, or substantially is not, heatable by penetration with a varying magnetic field.

Optionally, the embeddable portion comprises the first and second materials.

Optionally, the embeddable portion comprises one of the first and second materials and the base portion comprises the other one of the first and second materials.

Optionally, the or each susceptor portion is hollow or perforated, or comprises indentations, a mesh or an expanded metal.

Optionally, the or each susceptor portion comprises a pin, mesh or blade.

Optionally, the or each susceptor portion comprises a plurality of pins, meshes or blades.

Optionally, the or each susceptor portion comprises a plurality of apertures or recesses, wherein the apertures and/or recesses are filled with the aerosol-generating material.

Optionally, at least part of the or each susceptor portion is annular.

Optionally, the or each susceptor portion comprises a plurality of annular portions and, preferably, wherein the annular portions of each respective susceptor portion are arranged generally concentrically.

Optionally, the aerosol-generating material is non-liquid.

Optionally, the aerosol-generating material comprises tobacco.

Optionally, the susceptor extends the majority of the length of the consumable and, preferably, the susceptor extends substantially the entire length of the consumable.

The features described hereinbefore, including the features of the susceptor and/or aerosol-generating material, are applicable to any of the aspects of the disclosure described herein.

According to a sixth aspect of the present disclosure, there is provided a non-combustible aerosol provision system, comprising: the consumable according to the fourth aspect of the present disclosure or the fifth aspect of the present disclosure, and a non-combustible aerosol provision device for causing heating of the aerosol-generating material of the consumable to volatilise at least one component of the aerosol-generating material; wherein the device comprises a heating zone for receiving the consumable, and a magnetic field generator for generating a varying magnetic field for penetrating the susceptor portion of the consumable when the consumable is in the heating zone, thereby to cause heating of the aerosol-generating material.

Optionally, the device is for causing heating of the aerosol-generating material of the consumable to volatilise at least one component of the aerosol-generating material without burning the aerosol-generating material.

Optionally, the magnetic field generator comprises at least one coil.

Optionally, the coil is helical.

Optionally, the coil is a flat coil and may be a two-dimensional spiral.

Optionally, the system further comprises a second coil and, preferably, the second coil is helical.

Optionally, the magnetic field generator is configured to generate a varying magnetic field for penetrating the base portion of the susceptor portion when the consumable is at least partially in the heating zone.

Optionally, the coil is configured to generate a varying magnetic field for penetrating the base portion of the susceptor portion when the consumable is at least partially in the heating zone and wherein the second coil is configured to generate a varying magnetic field for penetrating the embeddable portion of the susceptor portion when the consumable is at least partially in the heating zone.

Optionally, the second coil extends about the circumference of at least a portion of the embeddable portion of the susceptor portion.

Optionally, the susceptor portion and/or heating material comprises one or more materials selected from the group consisting of: an electrically-conductive material, a magnetic material, and a magnetic electrically-conductive material.

Optionally, the susceptor portion and/or heating material comprises a metal or a metal alloy.

Optionally, the susceptor portion and/or heating material comprises one or more materials selected from the group consisting of: aluminium, gold, iron, nickel, cobalt, conductive carbon, graphite, steel, plain-carbon steel, mild steel, stainless steel, ferritic stainless steel, molybdenum, silicon carbide, copper, and bronze.

Optionally, the aerosol-generating material is a non-liquid material.

Optionally, the aerosol-generating material comprises tobacco.

Optionally, the aerosol-generating material is reconstituted aerosolisable material, such as reconstituted tobacco.

Further features and advantages will become apparent from the following description of preferred embodiments of the invention, given by way of example only, which is made with reference to the accompanying drawings.

### BRIEF DESCRIPTION OF THE DRAWINGS

Embodiments will now be described, by way of example only, with reference to accompanying drawings, in which:

FIG. 1 shows a schematic view of a susceptor arrangement according to one embodiment.

FIG. 2 shows a schematic view of a susceptor arrangement according to one embodiment.

FIG. 3 shows a schematic view of a susceptor arrangement according to one embodiment.

FIG. 4 shows a flow chart of a method according to one embodiment.

FIG. 5 shows a schematic view of an assembly according to one embodiment.

FIG. 6 shows a schematic view of a consumable according to one embodiment.

FIG. 7 shows schematic view of a susceptor arrangement according to one embodiment.

FIG. 8 shows a schematic view of an assembly according to one embodiment.

FIG. 9 shows a schematic view of an assembly according to one embodiment.

FIG. 10 shows a non-combustible aerosol provision system according to one embodiment.

### DETAILED DESCRIPTION

As used herein, “aerosol-generating material” is material that is capable of generating aerosol, for example when heated, irradiated or energized in any other way. Aerosol-generating material may, for example, be in the form of a solid, liquid or gel which may or may not contain an active substance and/or flavourants. In some embodiments, the aerosol-generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50 wt %, 60 wt % or 70 wt % of amorphous solid, to about 90 wt %, 95 wt % or 100 wt % of amorphous solid.

The aerosol-generating material may comprise one or more active substances and/or flavours, one or more aerosol-former materials, and optionally one or more other functional materials.

In some embodiments, the aerosol-generating material may comprise tobacco material, wherein tobacco material is any material comprising tobacco or derivatives thereof. The tobacco material may comprise one or more of ground tobacco, tobacco fibre, cut tobacco, extruded tobacco, tobacco stem, reconstituted tobacco and/or tobacco extract. In some embodiments, the aerosol-generating material may comprise a tobacco substitute.

As used herein, a “consumable” is an item comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use.

As used herein, a “susceptor” is a material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms.

When a susceptor is incorporated into a consumable, as heat is generated inside the susceptor itself, rather than by an external heat source by heat conductions, a rapid temperature rise in the consumable and more uniform heat distribution can be achieved, particularly through the selection of suitable materials and geometry, and suitable varying magnetic field magnitude and orientation relative to the susceptor. Moreover, as induction heating and magnetic hysteresis heating do not require physical connection to be provided between the source of the varying magnetic field and the susceptor, material deposits on the susceptor, such as residue or condensate, may be less of an issue, design freedom and control over the heating profile may be greater, and cost may be lower.

During manufacture of a consumable, for example a consumable for use with a non-combustible aerosol provision device, aerosol-generating material such as tobacco is placed in contact with a paper. The paper is then wrapped around the aerosol-generating material to encase the aerosol-generating material and create a rod. The rod is cut to a desired length, and a filter may subsequently be attached (typically at one end of the cut rod), to form the consumable.

A susceptor may be provided within such a consumable in order to enable heating of the consumable in any of the ways discussed above. Conventional consumables may not include a susceptor and hence the cutting equipment used to cut the rods to the desired length are typically configured to cut through the aerosol-generating material (e.g., tobacco) and the paper layer(s). However, if the susceptor is provided as a continuous uniform item (e.g., a strip of metal having uniform dimensions and uniform material properties) through the rod before the rod is cut to length, then damage may be caused to the existing cutting instruments used to cut the rod to the desired length on-line. Additionally, not only may the equipment not be suitable for cutting through the susceptor from a strength/robustness point of view, the time required to perform the cutting of the rods may be comparably longer when the continuous susceptor is present, thus impacting the production rate (and quantity) of consumables that can be manufactured.

FIG. 1 shows a schematic view of a susceptor arrangement 1 for use in a method of manufacturing a consumable for use with a non-combustible aerosol provision device, according to one embodiment. The susceptor arrangement 1 comprises susceptor portions 2 and a connector 3 joining the susceptor portions 2 to each other. This arrangement therefore represents a series of susceptor portions 2 physically connected to one another. The physical connection may be a direct connection (e.g., where the susceptor portions 2 are integrally formed with the connector 3) or an indirect connection (e.g., where the susceptor portions 2 are not physically connected to each other). The susceptors 2 are spaced apart from each other by the connector 3. The connector 3 performs several functions, including: maintaining the susceptor portions 2 at a predetermined separation distance from one another, enabling a single item which is more easily handled during manufacture, and maintaining the susceptor portions 2 in a uniform arrangement. For example, the connector 3 may reduce twisting of the susceptor portions 2 relative to one another such that the susceptor portions 2 are each placed at roughly the same location and at the same orientation during manufacture of the consumable.

The term “susceptor portions” herein should be understood to refer to the portions of the susceptor assembly which predominantly or exclusively act as the susceptor (or heater) when a consumable including a susceptor portion is exposed to a varying magnetic field. In some instances, the terms “susceptors” or “discrete susceptors” are used instead of susceptor portions to indicate that these are the portions of the susceptor arrangement 1 which predominantly act as a heater. As discussed below, the connector 3 in some embodiments may comprise or consist of material which heats up upon exposure to a varying magnetic field; however, generally speaking, the primary function of the connector 3 is not to act as the main source of heat in some implementations.

Two susceptors 2 are shown in FIG. 1. However, any suitable number of susceptors 2 may be comprised in the susceptor arrangement 1, for example, two, three, four, five or six susceptors 2. The susceptor arrangement 1 may comprise a sequence of alternating susceptors 2 and connectors 3. The susceptor arrangement 1 may be wound onto a reel or the like for convenient storage of the susceptor arrangement 1.

As shown in FIG. 1, the susceptor arrangement 1 comprises the susceptors 2 and a weakened region 4 of the susceptor arrangement 1 between the susceptors 2. The connector 3 comprises or consists of the weakened region 4. The weakened region 4 allows for the susceptors 2 to be more easily separated from each other, if desired. This reduces the risk of damaging any cutting instruments used to cut the susceptor arrangement 1 during consumable manufacture, as will be described below.

The weakened region 4 may be a region that is relatively weaker than each of the susceptors 2. For example, the weakened region 4 may be a region that is easier to cut than each of the susceptors 2.

In general, the, or each, weakened region is a region of the susceptor arrangement 1 having certain properties that enable the weakened region to be more easily cut that other regions of the susceptor arrangement (and in particular those regions containing the susceptors). In some embodiments, the weakened region 4 is formed by providing perforations in the susceptor arrangement 1. That is, in these embodiments, in the weakened region the amount of material to be cut is reduced relative to the other regions of the susceptor arrangement. Alternatively or additionally, the weakened region 4 may have a different geometric property (e.g. width and/or length) to the susceptors 2, for example as shown in FIG. 3. That is, in these embodiments, in the weakened region the amount of material to be cut is reduced relative to the other regions of the susceptor arrangement. In other embodiments, the weakened region 4 may alternatively or additionally comprise a different material from the susceptors 2.

In some embodiments, as shown in FIG. 1, the susceptors 2 are integrally formed with the weakened region 4. Alternatively, the susceptors 2 and the connector 3 may be formed as discrete elements and subsequently connected together.

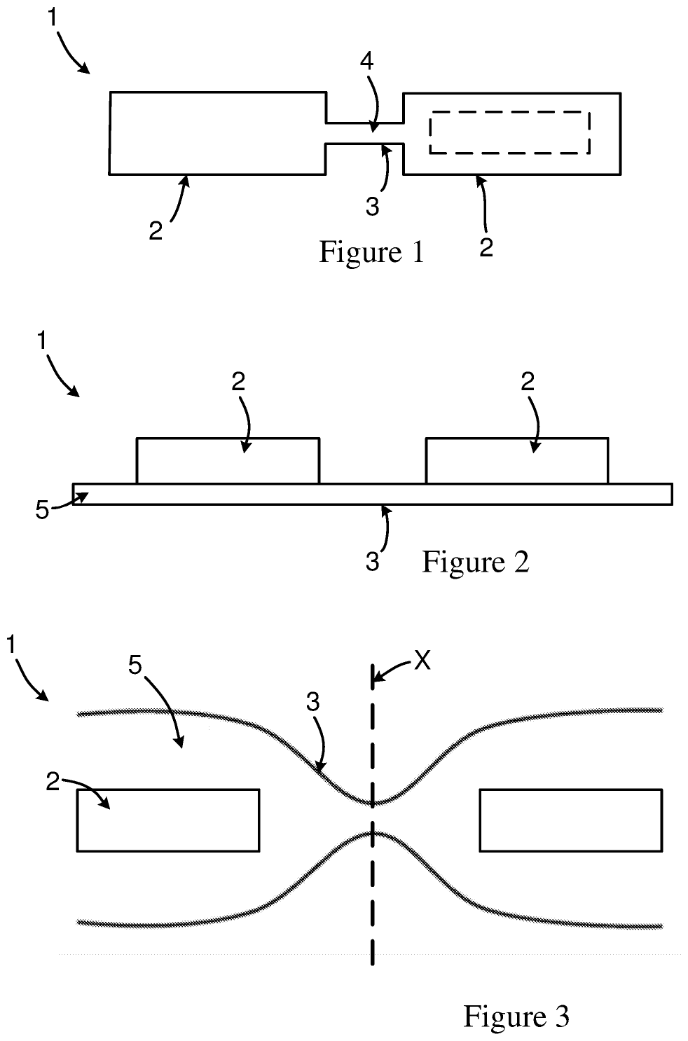

FIG. 2 shows a schematic view of a susceptor arrangement 1 according to one embodiment. As in FIG. 1, the susceptor arrangement 1 comprises discrete susceptors 2 and a connector 3. In the embodiment of FIG. 2, the connector 3 comprises a carrier 5 to which the susceptors 2 are affixed. The susceptors 2 may be affixed to the carrier 5 by any suitable means including, but not limited to, gluing, welding, etc. The type of affixing mechanism may be chosen based on the material of the carrier 5 and the material of the susceptor 2. In some embodiments, the susceptors 2 may be crimped onto the carrier 5 using any suitable method, so as to effectively staple the susceptors 2 to the carrier 5. In some embodiments, the susceptors 2 may be encapsulated by or embedded within the carrier 5. For example, the carrier 5 may comprise two laminae (such as two sheets of paper) that are adhered to each other to capture the susceptors 2 therebetween. The carrier 5 may help to prevent the susceptors 2 from twisting or warping and keep the susceptors 2 planar. In some embodiments, the susceptors 2 may not be planar. The carrier 5 may help the susceptors 2 to maintain their shape.

In some embodiments, the susceptor arrangement 1 is provided with markings on at least one surface thereof. For example, the marking may be provided on at least one surface of the carrier 5. The markings may aid in monitoring movement of the carrier 5 and/or the susceptor arrangement 1 during a manufacturing process. For example, the markings may be used to determine how much of the carrier 5 is disposed in a consumable and/or to adjust timing of the movement of the carrier 5. In some embodiments, the carrier 5 is provided on, or wound onto, a bobbin.

In some embodiments, the carrier 5 comprises heating material that is heatable by penetration with a varying magnetic field. Alternatively, the carrier 5 is free from heating material that is heatable by penetration with a varying magnetic field. The carrier 5 may comprise one or more of paper, metal foil, metal alloy foil and aerosol generating material, for example. In the embodiment of FIG. 2, a single carrier 5 is shown. In other embodiments, more than one carrier 5 may be utilised. For example, two carriers 5 may be affixed to opposite sides of the susceptors 2, so that the susceptors 2 are sandwiched between the carriers 5.

The susceptors 2 and/or heating material may comprise one or more materials selected from the group consisting of: an electrically-conductive material, a magnetic material, and a magnetic electrically-conductive material. In some embodiments, the susceptors and/or heating material comprises a metal or a metal alloy. In some embodiments, the susceptors and/or heating material comprises one or more materials selected from the group consisting of: aluminium, gold, iron, nickel, cobalt, conductive carbon, graphite, steel, plain-carbon steel, mild steel, stainless steel, ferritic stainless steel, molybdenum, silicon carbide, copper, and bronze.

FIG. 3 shows a schematic view of a susceptor arrangement 1 according to one embodiment. The susceptor arrangement 1 comprises susceptors 2 and a connector 3. The connector 3 comprises a carrier 5. As shown in FIG. 3, the carrier may comprise a weakened region along line X, which is formed by a change in geometric property of the carrier 5.

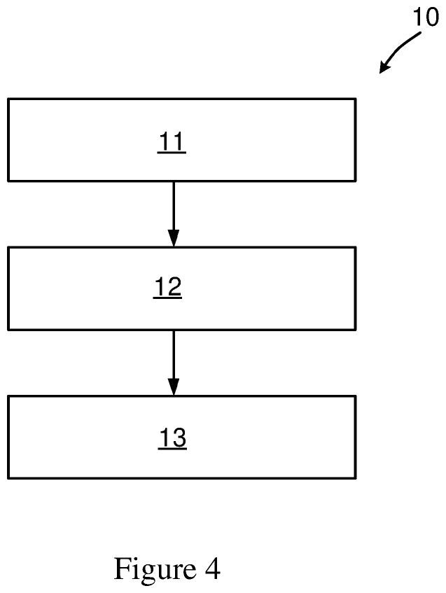

FIG. 4 shows a flowchart of a method 10 of manufacturing a consumable for use with a non-combustible aerosol provision device, according to one embodiment. The method 10 comprises providing 11 a susceptor arrangement 1 comprising discrete susceptors 2 and a connector 3 joining the susceptors 2 to each other. The susceptors 2 are spaced apart from each other by the connector 3. The method 10 also comprises forming 12 an assembly comprising the susceptor arrangement 1 and aerosol-generating material and dividing 13 the assembly. The dividing 13 comprises dividing the connector 3 and the aerosol-generating material.

In some embodiments, the dividing 13 comprises using a cutter to cut the connector 3. The cutter may be an on-line component of a consumable-manufacturing system, or may be separate to a consumable-manufacturing system. The cutter may be the same cutter used to cut the consumable to a desired length.

In some embodiments, the forming 12 comprises at least partially embedding the susceptor arrangement 1 in the aerosol-generating material. The forming 12 may comprise fully embedding the susceptor arrangement 1 in the aerosol-generating material.

In some embodiments, the forming 12 comprises combining the susceptor arrangement 1 with the aerosol-generating material on a wrapper and wrapping the wrapper around the susceptor arrangement 1 and the aerosol-generating material. The susceptor arrangement 1 may be placed on the wrapper before the aerosol-generating material. Alternatively, the aerosol-generating material may be placed on the wrapper before the susceptor arrangement 1.

As discussed above, in some embodiments, the connector 3 comprises a weakened region of the susceptor arrangement 1. The susceptors 2 may be integrally formed with the weakened region.

In some embodiments, the connector 3 comprises a carrier to which the susceptors 2 are affixed. The carrier may be made from any of the materials discussed above for the carrier.

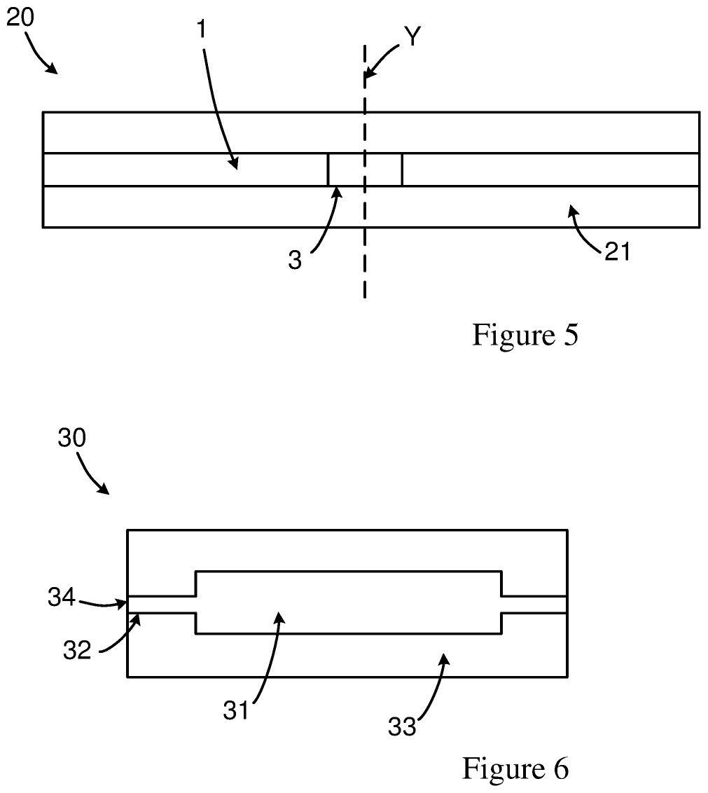

FIG. 5 shows a schematic view of an assembly 20 for use with a method of manufacturing a consumable for use with a non-combustible aerosol provision device, according to one embodiment. The assembly 20 comprises a susceptor arrangement 1 and aerosol-generating material 21 in thermal contact with the susceptor arrangement 1. The susceptor arrangement 1 may be any susceptor arrangement described herein, such as one of the susceptor arrangements 1 described in relation to FIGS. 1 to 3. The assembly 20 is dividable by a process comprising dividing the connector 3 and the aerosol-generating material 21. In one embodiment, the dividing forms individual objects. Each of the individual objects may be a consumable or may be used in the manufacture of a consumable. For example, the assembly 20 may be dividable along line Y. In some embodiments, the assembly 20 comprises a wrapper that is wrapped around the susceptor arrangement 1 and the aerosol-generating material 21.

FIG. 6 shows a schematic view of a consumable 30 for use with a non-combustible aerosol provision device, according to one embodiment. The consumable 30 comprises at least one discrete susceptor 31 and a connector portion 32 affixed to or integrally formed with the or each susceptor 31. The consumable comprises aerosol-generating material 33 in thermal contact with the or each susceptor 31. The connector portion 32 extends to at least one end 34 of the aerosol-generating material 33. As shown in FIG. 6, in one embodiment respective connector portions 32 may extend to two opposite ends of the aerosol-generating material 33. In one embodiment, the connector portion 32 is a part of a connector described herein.

In some embodiments, the consumable 30 is manufactured according to a method described herein. In particular, the consumable 30 may be manufactured according to the method described with relation to FIG. 4.

In some embodiments, the consumable 30 comprises a susceptor arrangement that comprises the at least one susceptor 31, wherein the connector portion 32 comprises a weakened region of the susceptor arrangement.

As shown in FIG. 6, the weakened region may be integrally formed with the at least one susceptor 31. Alternatively, the weakened region may be formed separately to and subsequently attached to the at least one susceptor 31, such as in the form of a carrier.

In some embodiments, the connector portion 32 comprises a carrier to which the at least one susceptor 31 is affixed. The carrier may comprise heating material that is heatable with a varying magnetic field. Alternatively, the carrier may be free from heating material that is heatable by penetration with a varying magnetic field. In some embodiments, the carrier comprises one or more of paper, metal foil, metal alloy foil and aerosol-generating material.

In some embodiments, the or each susceptor 31 is at least partially embedded in the aerosol-generating material 33. For example, the or each susceptor 31 may be embedded such that at least a portion of the susceptor 31 protrudes from the aerosol-generating material 33. Alternatively, the or each susceptor 31 may be fully embedded in the aerosol-generating material 33 such that no part of the susceptor 31 protrudes from the aerosol-generating material 33. This can help to avoid a user contacting the susceptor 31, which may be hot, during use of the consumable 30.

As shown in FIG. 6, the or each susceptor 31 may be substantially coaxial with a central axis of the consumable 30. Alternatively, the or each susceptor 31 may be disposed in any other way that allows the or each susceptor 31 to heat the aerosol-generating material 33 of the consumable 30.

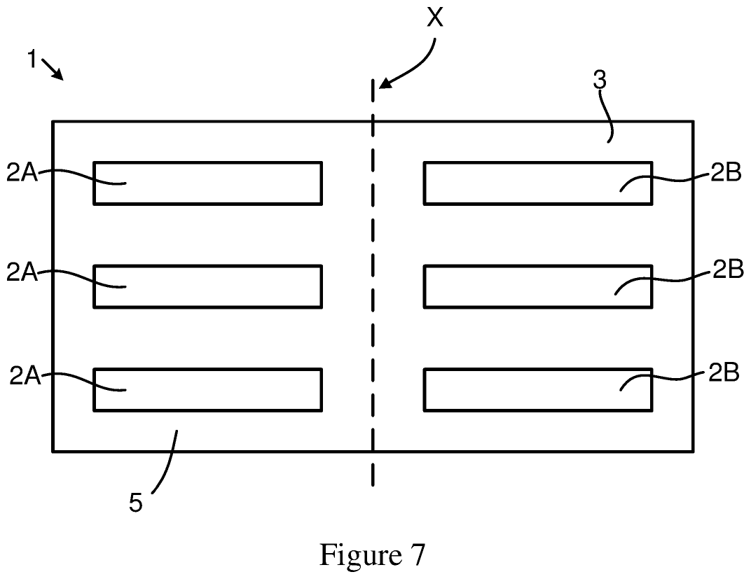

FIG. 7 shows a schematic view of a susceptor arrangement 1 according to one embodiment. The susceptor arrangement 1 comprises a plurality of first susceptor portions 2A and a plurality of second susceptor portions 2B. The susceptor arrangement 1 further comprises a connector 3 that connects the first and second susceptor portions 2A, 2B.

In some embodiments, the connector 3 comprises a carrier 5, for example, a carrier 5 similar to the carrier 5 of the embodiment of FIG. 2 or the embodiment of FIG. 3. For instance, the carrier 5 may comprise heating material that is heatable by penetration with a varying magnetic field. Alternatively, the carrier 5 may be free from heating material that is heatable by penetration with a varying magnetic field. The carrier 5 may comprise one or more of paper, metal foil, metal alloy foil and aerosol generating material, for example. In the embodiment of FIG. 7, a single carrier 5 is shown. In other embodiments, more than one carrier 5 may be provided and, for example, two carriers 5 may be affixed to the first and second susceptor portions 2A, 2B on opposite sides thereof so that the susceptor portions 2A, 2B are sandwiched between the carriers 5.

The plurality of first and second susceptor portions 2A, 2B are affixed to the carrier 5 using any of the previously described methods, for example, using adhesives.

Each first susceptor portion 2A is spaced from a respective second susceptor portion 2B by the connector 3, which in the present example comprises the carrier 5. An assembly comprising the susceptor arrangement 1 and aerosol-generating material is formed and processed according to any of the steps previously described, including any of the steps of the method of FIG. 4 and, optionally, all of the steps of the method of FIG. 4. In the present example, the assembly is divided by dividing the connector 3 and the aerosol-generating material, for example, using a cutter.

The first susceptor portions 2A may be located parallel to each other. For example, the longitudinal axes of the first susceptor portions 2A may be parallel to each other. Additionally, or alternatively, the second susceptor portions 2B may be located parallel to each other. For example, the longitudinal axes of the second susceptor portions 2B may be parallel to each other.

In the embodiment of FIG. 7, each first susceptor portion 2A is aligned with a corresponding second susceptor portion 2B. The longitudinal axis of each first susceptor portion 2A is aligned with the longitudinal axis of a corresponding second susceptor portion 2B in a direction perpendicular to the longitudinal axes. However, it should be recognised that in alternative embodiments the first and second susceptor portions 2A, 2B may not be aligned and may be staggered, for example, being staggered in a direction perpendicular to a central or longitudinal axis of each susceptor portions 2A, 2B.

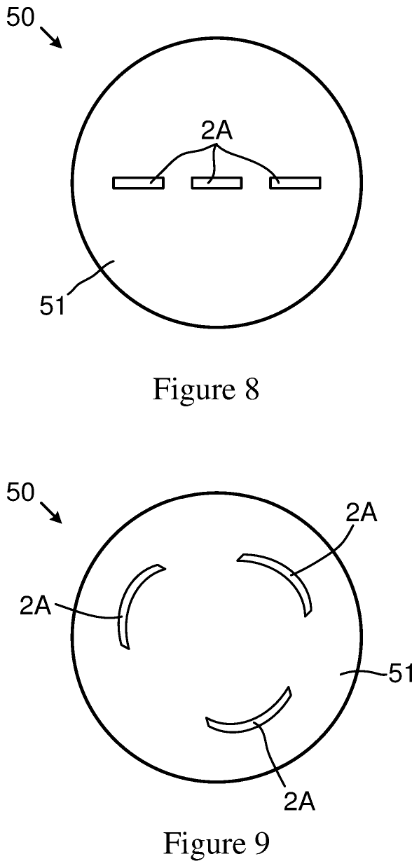

In the embodiment of FIG. 8, the susceptor arrangement 1 comprises three first susceptor portions 2A and three second susceptor portions 2B. However, it should be recognised that in other embodiments a different number of first and/or second susceptor portions 2A, 2B may be provided, for example, two, three, four, five, six, seven, eight, nine or ten first susceptor portions 2A and/or second susceptor portions 2B. The susceptor arrangement 1 may comprise an equal number of first and second susceptor portions 2A, 2B or a different number of first and second susceptor portions 2A, 2B.

In some embodiments, the first and second susceptor portions 2A, 2B are the same shape. In other embodiments, the first susceptor portions 2A are a different shape to the second susceptor portions 2B.

FIG. 8 shows a schematic cross-sectional view of an assembly 50 for use with a method of manufacturing a consumable for use with a non-combustible aerosol provision device, according to one embodiment. The assembly 50 comprises a susceptor arrangement 1 according to the embodiment of FIG. 7 and aerosol-generating material 51 in thermal contact with the susceptor arrangement 1. As with the previous embodiments, the assembly 50 is dividable by a process comprising dividing the connector 3 and the aerosol-generating material 51. For instance, the assembly 50 may be divided along the carrier 5 between the first and second susceptor portions 2A, 2B such that a portion of the carrier 5 and the first susceptor portions 2A are detached from another portion of the carrier 5 and the second susceptor portions 2B.

In one embodiment, the dividing forms individual objects. For instance, in some embodiments a first object is formed comprising a portion of the aerosol generating material 51, a portion of the carrier 5, and the first susceptor portions 2A. Also, a second object is formed comprising another portion of the aerosol generating material 51, another portion of the carrier 5, and the second susceptor portions 2B. Each of the individual objects may be a consumable or may be used in the manufacture of a consumable. For example, the assembly 50 may be dividable such that the susceptor arrangement 1 is divided along line X shown in FIG. 7. In some embodiments, the assembly 50 comprises a wrapper that is wrapped around the susceptor arrangement 1 and the aerosol-generating material 51.

In some embodiments, the or each connector 3 of the susceptor arrangement 1 comprises a weakened region to facilitate division of the susceptor arrangement 1, as previously described.

Providing a plurality of susceptor portions in a consumable helps to promote a more even heating of the aerosol-generating material. In some embodiments, the susceptor portions of the consumable are substantially evenly spaced in the consumable to further promote even heating of the aerosol-generating material.

In some embodiments, the consumable (not shown) comprises a plurality of discrete susceptor portions and a connector portion affixed to or integrally formed with each susceptor portion. In some embodiments, a connector portion may be affixed to or integrally formed with all of the susceptor portions, for example, all of the susceptor portions may be affixed to a single carrier 5 or sandwiched between a pair of carriers 5. In another embodiment, the consumable comprises a plurality of connector portions, wherein respective connector portions are connected to respective first and second susceptor portions.

The consumable comprises aerosol-generating material in thermal contact with each susceptor portion. The or each connector portion extends to at least one end of the aerosol-generating material, and may extend to two opposite ends of the aerosol-generating material. In one embodiment, the or each connector portion is a part of a connector described herein.

In FIG. 8, the plurality of first susceptor portions 2A are aligned in a direction perpendicular to the central axis of the assembly 50 and the plurality of second susceptor portions (not shown in FIG. 8) are aligned in a direction perpendicular to the central axis of the assembly 50. However, it should be recognised that other relative positions of the susceptor portions 2A, 2B are possible. For example, FIG. 9 is a cross-sectional view of another embodiment wherein the first susceptor portions 2A are disposed about the central axis of the assembly 50 and may be spaced therefrom. Similarly, the second susceptor portions (not shown in FIG. 9) are disposed about the central axis of the assembly 50 and may be spaced therefrom. Such an arrangement of the susceptor portions helps to promote an even heating of the aerosol-generating material. Optionally, each susceptor portion 2A, 2B may be curved such that it subtends part of the way about the central axis of the assembly 50. However, in other embodiments one, more than one, or each susceptor portion may be substantially flat.

It should be recognised that the susceptor arrangement 1 comprising a plurality of first susceptor portions 2A and a plurality of second susceptor portions 2B may have the features of any of the susceptor arrangements described herein (including any of the embodiments of FIGS. 1 to 6) but adapted to include to include a plurality of first susceptor portions and a plurality of second susceptor portions. For instance, in a modification of the embodiment of FIG. 1, there is provided a susceptor arrangement comprising a plurality of first susceptor portions 2A, a plurality of second susceptor portions 2B and a plurality of connectors 3 each of the configuration described above in relation to FIG. 1. Each first susceptor portion 2A is connected to a corresponding second susceptor portion 2B by a corresponding connector 3. The first susceptor portions 2A, second susceptor portions 2B and connectors 3 together form a susceptor arrangement. The connectors 3 may be spaced from each other. The susceptor arrangement and aerosol-generating material is then formed into an assembly, and the assembly is divided by dividing the connectors and the aerosol-generating material.

In other embodiments, the plurality of first susceptor portions 2A and plurality of second susceptor portions 2B are connected to a shared connector 3, for example, being affixed to a shared carrier 5 (for example, in a modification of the embodiment of FIG. 2 or FIG. 3). The susceptor portions 2A, 2B being connected to the same connector 3 allows for accurate relative positioning of the susceptor portions 2A, 2B during the remaining processing steps.

In FIGS. 8 and 9 the carrier 5 is not shown, however it should be recognised that the first and second susceptor portions 2A, 2B may be held in place affixed to the carrier 5 within the assembly 50. In other embodiments, the carrier 5 is omitted.

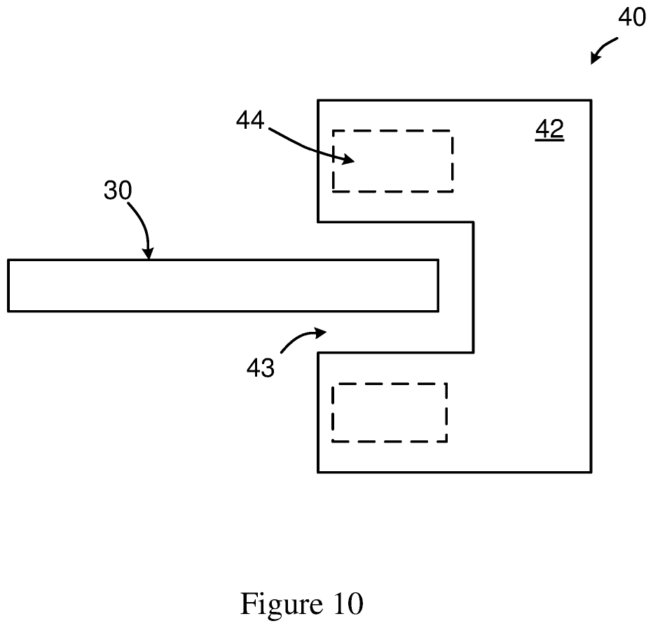

FIG. 10 shows a schematic view of a non-combustible aerosol provision system 40 according to an embodiment. The non-combustible aerosol provision system 40 comprises a consumable 30. The consumable 30 may be any consumable 30 described herein, such as the consumable described with reference to FIG. 6 or any variant thereof discussed herein. The system also comprises a non-combustible aerosol provision device 42 for causing heating of the aerosol-generating material of the consumable 30 to volatilise at least one component of the aerosol-generating material. The device 42 comprises a heating zone 43 for receiving the consumable 30 and a magnetic field generator 44 for generating a varying magnetic field for penetrating the susceptor of the consumable 30 when the consumable 30 is in the heating zone 43, thereby causing heating of the aerosol generating material.

In some embodiments, the device 42 is for causing heating of the aerosol-generating material of the consumable 30 to volatilise at least one component of the aerosol-generating material without burning the aerosol-generating material.

In some embodiments, the aerosol-generating material is a non-liquid material. In some embodiments, the aerosol-generating material comprises tobacco. In some embodiments, the aerosol-generating material is reconstituted aerosolisable material, such as reconstituted tobacco.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method of manufacturing a consumable for use in a non-combustible aerosol provision device, the method comprising:
providing a susceptor arrangement comprising first and second susceptor portions and a connector joining the first and second susceptor portions to each other, wherein the first and second susceptor portions are spaced apart from each other by the connector;
forming an assembly comprising the susceptor arrangement and aerosol-generating material; and
dividing the assembly, wherein the dividing comprises dividing the connector and the aerosol-generating material.

2. The method of claim 1, wherein the dividing comprises using a cutter to cut the connector.

3. The method of claim 1 or claim 2, wherein the forming comprises at least partially embedding the susceptor arrangement in the aerosol-generating material.

4. The method of any one of claims 1 to 3, wherein the forming comprises:
combining the susceptor arrangement with the aerosol-generating material on a wrapper; and
wrapping the wrapper around the susceptor arrangement and the aerosol-generating material.

5. The method of claim 4, wherein the susceptor arrangement is placed on the wrapper before the aerosol-generating material.

6. The method of claim 4, wherein the aerosol-generating material is placed on the wrapper before the susceptor arrangement.

7. A susceptor arrangement for use in a method of manufacturing a consumable for use with a non-combustible aerosol provision device, the susceptor arrangement comprising first and second susceptor portions and a connector joining the first and second susceptor portions to each other, wherein the first and second susceptor portions are spaced apart from each other by the connector.

8. The susceptor arrangement of claim 7, wherein the connector comprises a weakened region of the susceptor arrangement.

9. The susceptor arrangement of claim 8, wherein the susceptor portions are integrally formed with the weakened region.

10. The susceptor arrangement of claim 9, wherein the susceptor arrangement comprises at least one further susceptor portion and at least one further connector, wherein the susceptor arrangement is arranged such that a repeating sequence of susceptor portion followed by connector followed by susceptor portion is present.

11. The susceptor arrangement of claim 7, wherein the connector comprises a carrier to which the susceptor portions are affixed.

12. The susceptor arrangement of claim 11, wherein the susceptor arrangement comprises at least one further susceptor portion and wherein the first susceptor portion, the second susceptor portion and at least one further susceptor portion are affixed to the carrier.

13. The susceptor arrangement of claim 11 or 12, wherein the susceptor portions are spaced apart from one another on the carrier, and wherein the carrier comprises a weakened region between the susceptor portions.

14. The susceptor arrangement of any one of claims 11 to 13, wherein the carrier comprises heating material that is heatable by penetration with a varying magnetic field.

15. The susceptor arrangement of any one of claims 11 to 13, wherein the carrier is free from heating material that is heatable by penetration with a varying magnetic field.

16. The susceptor arrangement of any one of claims 11 to 15, wherein the carrier comprises one or more of: paper, metal foil, metal alloy foil, and aerosol-generating material.

17. The method of any one of claims 1 to 6 or the susceptor arrangement of any one of claims 7 to 16, wherein the susceptor arrangement comprises a plurality of first susceptor portions and a plurality of second susceptor portions.

18. The method or susceptor arrangement of claim 17, wherein the connector joins each first susceptor portion to a respective second susceptor portion such that each first susceptor portion is spaced from the respective second susceptor portion by the connector.

19. The method or susceptor arrangement of claim 17, wherein the susceptor arrangement comprises a plurality of connectors, each connector joining a first susceptor portion to a respective second susceptor portion such that each first susceptor portion is spaced from the respective second susceptor portion by the respective connector.

20. The method or susceptor arrangement of claim 19, wherein dividing the assembly comprises dividing each connector and the aerosol-generating material.

21. The method or susceptor arrangement of any one of claims 17 to 20, wherein the first susceptor portions of the assembly are substantially equally spaced from each other and/or the second susceptor portions of the assembly are substantially equally spaced from each other.

22. An assembly for use in a method of manufacturing a consumable for use with a non-combustible aerosol provision device, the assembly comprising:
the susceptor arrangement of any one of claims 7 to 21; and
aerosol-generating material in thermal contact with the susceptor arrangement;
wherein the assembly is dividable by a process comprising dividing the connector and the aerosol-generating material.

23. A consumable for use with a non-combustible aerosol provision device, the consumable being manufactured according to a method comprising the method of any one of claims 1 to 6 or claims 17 to 21.

24. A consumable for use with a non-combustible aerosol provision device, the consumable comprising:
at least one susceptor portion and a connector portion affixed to or integrally formed with the or each susceptor portion, and
aerosol-generating material in thermal contact with the or each susceptor portion;
wherein the connector portion extends to at least one end of the aerosol-generating material.

25. The consumable of claim 24, comprising a susceptor arrangement that comprises the at least one susceptor portion, wherein the connector portion comprises a weakened region of the susceptor arrangement.

26. The consumable of claim 25, wherein the weakened region is integrally formed with the at least one susceptor portion.

27. The consumable of claim 24, wherein the connector portion comprises a carrier to which the at least one susceptor portion is affixed.

28. The consumable of any one of claims 23 to 27, wherein the or each susceptor portion is at least partially embedded in the aerosol-generating material.

29. The consumable of any one of claims 23 to 28, wherein the or each susceptor portion is substantially coaxial with a central axis of the consumable.

30. The consumable of any one of claims 23 to 29, comprising a plurality of susceptor portions.

31. The method of any one of claims 1 to 6 or claims 17 to 21, the susceptor arrangement of any one of claims 7 to 21, the assembly according to claim 22, or the consumable according to any one of claims 23 to 30, wherein the or each susceptor portion comprises one or more materials selected from the group consisting of: aluminium, gold, iron, nickel, cobalt, conductive carbon, graphite, steel, plain-carbon steel, mild steel, stainless steel, ferritic stainless steel, molybdenum, silicon carbide, copper, and bronze.

32. The method of any one of claim 1 to 6, 17 to 21 or 31, the susceptor arrangement of any one of claim 7 to 21 or 31, the assembly according to claim 22 or claim 31, or the consumable according to any one of claims 23 to 31, wherein the or each susceptor portion comprises nickel.

33. The method of any one of claim 1 to 6, 17 to 21, 31 or 32, the susceptor arrangement of any one of claim 7 to 21, 31 or 32, the assembly according to claim 22, 31 or 32, or the consumable according to any one of claims 23 to 32, wherein the or each susceptor portion comprises steel with a nickel coating.

34. The method of any one of claims 1 to 6, 17 to 21 or 31 to 33, the susceptor arrangement of any one of claims 7 to 21 or 31 to 33, the assembly according to claim 22 or 31 to 33, or the consumable according to any one of claims 23 to 33, wherein the susceptor arrangement comprises perforations.

35. The method of any one of claims 1 to 6, 17 to 21, or 31 to 34, the susceptor arrangement of any one of claims 7 to 21 or 31 to 34, the assembly according to claim 22 or 31 to 34, or the consumable according to any one of claims 23 to 34, wherein the susceptor arrangement comprises a weakened region.

36. The method of any one of claims 1 to 6, 17 to 21, or 31 to 35, the susceptor arrangement of any one of claims 7 to 21 or 31 to 35, the assembly according to claim 22 or 31 to 35, or the consumable according to any one of claims 23 to 35, wherein the susceptor arrangement comprises first and second materials that are different.

37. The method, susceptor arrangement, assembly or consumable of claim 36, wherein the or each susceptor portion comprises a first region comprising the first material and a second region comprising the second material.

38. The method, susceptor arrangement, assembly or consumable of claim 36 or claim 37, wherein the first and second materials have a different electrical conductivity and/or magnetic electrical conductivity.

39. The method, susceptor arrangement, assembly or consumable of any one of claims 36 to 38, wherein the first material comprises a material that is heatable by penetration with a varying magnetic field and the second material comprises a material that is not, or substantially is not, heatable by penetration with a varying magnetic field.

40. The method, susceptor arrangement, assembly or consumable of any one of claims 36 to 39, wherein one of first and second materials is coated with the other one of the first and second materials.

41. The method, susceptor arrangement, assembly or consumable of claim 40, wherein the first material is coated with the second material.

42. The method, susceptor arrangement, assembly or consumable of any one of claims 36 to 41, wherein the first and second materials are configured such that, in use, when the first and second materials are penetrated by a varying magnetic field, the penetration of the first and second materials by the varying magnetic field causes a temperature difference between the first and second materials.

43. The method, susceptor arrangement, assembly or consumable of any one of claims 36 to 42, wherein the first and second materials have different thermal masses.

44. The method of any one of claims 1 to 6, 17 to 21, or 31 to 43, the susceptor arrangement of any one of claims 7 to 21 or 31 to 43, the assembly according to claim 22 or 31 to 43, or the consumable according to any one of claims 23 to 43, wherein the or each susceptor portion comprises a base portion and an embeddable portion for at least partially embedding in aerosol-generating material.

45. The method, susceptor arrangement, assembly or consumable of claim 44, wherein the base portion is generally flat.

46. The method, susceptor arrangement, assembly or consumable of claim 44 or 45, wherein the base portion is generally circular.

47. The method, susceptor arrangement, assembly or consumable of any one of claims 44 to 46, wherein the base portion is comprises a material that is heatable by penetration with a varying magnetic field.

48. The method, susceptor arrangement, assembly or consumable of any one of claims 44 to 47, wherein the embeddable portion comprises a thermally conductive material.

49. The method, susceptor arrangement, assembly or consumable of any one of claims 44 to 48, wherein the embeddable portion comprises a material that is heatable by penetration with a varying magnetic field.

50. The method, susceptor arrangement, assembly or consumable of any one of claims 44 to 49, wherein the embeddable portion comprises a material that is not, or substantially is not, heatable by penetration with a varying magnetic field.

51. The method, susceptor arrangement, assembly or consumable of any one of claims 44 to 50, when dependent on any one of claims 36 to 43, wherein the embeddable portion comprises the first and second materials.

52. The method, susceptor arrangement, assembly or consumable of any one of claims 44 to 51, when dependent on any one of claims 36 to 43, wherein the embeddable portion comprises one of the first and second materials and the base portion comprises the other one of the first and second materials.

53. The method of any one of claims 1 to 6, 17 to 21, or 31 to 52, the susceptor arrangement of any one of claims 7 to 21 or 31 to 52, the assembly according to claim 22 or 31 to 52, or the consumable according to any one of claims 23 to 52, wherein the or each susceptor portion is hollow or perforated, or comprises indentations, a mesh or an expanded metal.

54. The method of any one of claims 1 to 6, 17 to 21, or 31 to 53, the susceptor arrangement of any one of claims 7 to 21 or 31 to 53, the assembly according to claim 22 or 31 to 53, or the consumable according to any one of claims 23 to 53, wherein the or each susceptor portion comprises a pin, mesh or blade.

55. The method, susceptor arrangement, assembly or consumable of claim 54, wherein the or each susceptor portion comprises a plurality of pins, meshes or blades.

56. The method of any one of claims 1 to 6, 17 to 21 or 31 to 55, the susceptor arrangement of any one of claims 7 to 21 or 31 to 55, the assembly according to claim 22 or 31 to 55, or the consumable according to any one of claims 23 to 55, wherein the or each susceptor portion comprises a plurality of apertures or recesses, wherein the apertures and/or recesses are filled with the aerosol-generating material.

57. The method of any one of claims 1 to 6, 17 to 21, or 31 to 56, the susceptor arrangement of any one of claims 7 to 21 or 31 to 56, the assembly according to claim 22 or 31 to 56, or the consumable according to any one of claims 23 to 56, wherein at least part of the or each susceptor portion is annular.

58. The method, susceptor arrangement, assembly or consumable of claim 57, wherein the or each susceptor portion comprises a plurality of annular portions and, preferably, wherein the annular portions of each respective susceptor portion are arranged generally concentrically.

59. The method of any one of claims 1 to 6, 17 to 21, or 31 to 58, the susceptor arrangement of any one of claims 7 to 21 or 31 to 58, the assembly according to claim 22 or 31 to 58, or the consumable according to any one of claims 23 to 58, wherein the aerosol-generating material is non-liquid.

60. The method of any one of claims 1 to 6, 17 to 21, or 31 to 59, the susceptor arrangement of any one of claims 7 to 21 or 31 to 59, the assembly according to claim 22 or 31 to 59, or the consumable according to any one of claims 23 to 59, wherein the aerosol-generating material comprises tobacco.

61. The method of any one of claims 1 to 6, 17 to 21, or 31 to 60, the susceptor arrangement of any one of claims 7 to 21 or 31 to 60, the assembly according to claim 22 or 31 to 60, or the consumable according to any one of claims 23 to 60, wherein the susceptor extends the majority of the length of the consumable and, preferably, the susceptor extends substantially the entire length of the consumable.

62. A non-combustible aerosol provision system, comprising:
the consumable of any one of claims 23 to 61, and
a non-combustible aerosol provision device for causing heating of the aerosol-generating material of the consumable to volatilise at least one component of the aerosol-generating material;
wherein the device comprises a heating zone for receiving the consumable, and a magnetic field generator for generating a varying magnetic field for penetrating the susceptor portion of the consumable when the consumable is in the heating zone, thereby to cause heating of the aerosol-generating material.

63. The system of claim 62, wherein the device is for causing heating of the aerosol-generating material of the consumable to volatilise at least one component of the aerosol-generating material without burning the aerosol-generating material.

64. The system of claim 62 or 63, wherein the magnetic field generator comprises at least one coil.

65. The system of claim 64, wherein the coil is helical.

66. The system of claim 64, wherein the coil is a flat coil, and may be a two-dimensional spiral.

67. The system of claim 66, comprises a second coil and, preferably, the second coil is helical.

68. The system of any one of claims 62 to 67, when dependent on any one of claims 44 to 52, wherein the magnetic field generator is configured to generate a varying magnetic field for penetrating the base portion of the susceptor portion when the consumable is at least partially in the heating zone.

69. The system of claim 68, when dependent on claim 67, wherein the coil is configured to generate a varying magnetic field for penetrating the base portion of the susceptor portion when the consumable is at least partially in the heating zone and wherein the second coil is configured to generate a varying magnetic field for penetrating the embeddable portion of the susceptor portion when the consumable is at least partially in the heating zone.

70. The system of claim 69, wherein the second coil extends about the circumference of at least a portion of the embeddable portion of the susceptor portion.
